(19) United States
(12) Patent Application Publication
(10) Pub. No.: US 2016/0264775 A1
(43) Pub. Date: Sep. 15, 2016

(54) COMPOSITE COMPOSITIONS CONTAINING CO-PRODUCT OF A LIGNOCELLULOSIC BIOMASS PROCESS

(71) Applicant: E I DU PONT DE NEMOURS AND COMPANY, Wilmington, DE (US)

(72) Inventors: Paul Joseph Fagan, Wilmington, DE (US); Kayleigh J. Ferguson, Greenville, DE (US); Katrina Kratz, Chadds Ford, PA (US); Brian D. Mather, Newark, DE (US)

(21) Appl. No.: 15/066,521

(22) Filed: Mar. 10, 2016

Related U.S. Application Data
(60) Provisional application No. 62/132,088, filed on Mar. 12, 2015.

(51) Int. Cl. C08L 67/02; E02D 3/00; A01C 21/00

(52) U.S. Cl. CPC C08L 67/02; A01C 21/00; E02D 3/005

(57) ABSTRACT

The filter cake co-product of a lignocellulosic biomass fermentation process can be combined with a polymer to make a moldable composite composition that is useful in landscape and agricultural applications. The composite composition may be formed into a composite material for use, and applied to a landscape or agricultural site. The composite composition may also contain lignocellulosic syrup.

### CROSS-REFERENCE TO RELATED APPLICATIONS

This application claims the benefit of priority to U.S. Provisional Patent Application No. 62/132,088, filed on Mar. 12, 2015, which is incorporated by reference in its entirety.

### FIELD OF THE INVENTION

The invention relates to the field of lignocellulosic biomass process co-products. More specifically, compositions containing lignocellulosic biomass process co-products and polymers are useful in landscape and agricultural applications.

### BACKGROUND OF THE INVENTION

The landscape and agricultural industries are always looking for new products to be used in applications such as enhancing plant growth, controlling weeds, and preventing soil erosion. Thus various types of materials have been introduced into the market to address these issues.

In recent years, there has been a significant demand for application of materials from renewable resources in various end uses, and to reduce the production and applications of chemicals and materials that can be hazardous to the environment.

Bio-refineries producing second generation biofuels, alcohols, and other products from lignocellulosic biomass can provide opportunities to obtain new materials suitable to be used for a variety of applications in landscaping and agriculture.

### SUMMARY OF THE INVENTION

In one aspect the invention provides a composite composition comprising:

a) lignocellulosic filter cake;

b) at least one polymer; and

c) optionally lignocellulosic syrup;

wherein the composition is moldable.

In some aspects the composite composition is in a form selected from the group consisting of a film, an object, and a pellet; wherein the form is smooth, textured, or a combination thereof.

In another aspect the invention provides a method for providing a landscape or agricultural composite material comprising:

a) providing lignocellulosic filter cake;

b) providing at least one polymer;

c) optionally providing lignocellulosic syrup;

d) contacting the lignocellulosic filter cake of (a), the polymer of (b); and optionally the lignocellulosic syrup of (c) forming a composite mixture;

e) molding the composite mixture of (d) into a form;

wherein the form is a composite material that is applicable to landscape or agricultural uses.

In a further aspect the invention provides a method of treating a landscape or agricultural site comprising;

a) providing the composite composition presented above; and

b) applying the composite composition of (a) to a landscape or agricultural site.

### DETAILED DESCRIPTION

It is the object of the instant disclosure to provide composite compositions containing lignocellulosic filter cake co-product of a lignocellulosic biomass fermentation process and polymers. Optionally the compositions also contain lignocellulosic syrup co-product. These composite compositions are useful in landscape and agricultural applications. In addition, methods of providing and using the composites are also provided.

### Definitions

The following definitions and abbreviations are to be used for the interpretation of the claims and the specification.

As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The indefinite articles “a” and “an” preceding an element or component of the disclosure are intended to be nonrestrictive regarding the number of instances (i.e. occurrences) of the element or component.

Therefore “a” or “an” should be read to include one or at least one, and the singular word form of the element or component also includes the plural unless the number is obviously meant to be singular.

As used herein, the term “about” modifying the quantity of an ingredient or reactant of the disclosure employed refers to variation in the numerical quantity that can occur, for example, through typical measuring and liquid handling procedures used for making concentrates or use solutions in the real world; through inadvertent error in these procedures; through differences in the manufacture, source, or purity of the ingredients employed to make the compositions or carry out the methods; and the like.

The term “about” also encompasses amounts that differ due to different equilibrium conditions for a composition resulting from a particular initial mixture. Whether or not modified by the term “about”, the claims include equivalents to the quantities. In one embodiment, the term “about” means within 10% of the reported numerical value, preferably within 5% of the reported numerical value.

The term “fermentable sugar” refers to oligosaccharides and monosaccharides that can be used as a carbon source by a microorganism in a fermentation process.

The term “lignocellulosic” refers to a composition comprising both lignin and cellulose. Lignocellulosic material may also comprise hemicellulose.

The term “cellulosic” refers to a composition comprising cellulose and additional components, including hemicellulose.

The term “saccharification” refers to the production of fermentable sugars from polysaccharides.

The term “pretreated biomass” means biomass that has been subjected to pretreatment prior to saccharification. The pretreatment may take the form of physical, thermal or chemical means and combinations thereof.

The term “lignocellulosic biomass” refers to any lignocellulosic material and includes materials comprising cellulose, hemicellulose, lignin, starch, oligosaccharides and/or monosaccharides. Biomass can also comprise additional components, such as protein and/or lipid. Biomass can be derived from a single source, or biomass can comprise a mixture derived from more than one source; for example, biomass could comprise a mixture of corn cobs and corn stover, or a mixture of grass and leaves. Lignocellulosic biomass includes, but is not limited to, bioenergy crops, agricultural residues, municipal solid waste, industrial solid waste, sludge from paper manufacture, yard waste, wood and forestry waste. Examples of biomass include, but are not limited to, corn cobs, crop residues such as corn husks, corn stover, grasses (including Miscanthus), wheat straw, barley straw, hay, rice straw, switchgrass, waste paper, sugar cane bagasse, sorghum material, soybean plant material, components obtained from milling of grains or from using grains in production processes (such as DDGS: dried distillers grains with solubles), trees, branches, roots, leaves, wood chips, sawdust, shrubs and bushes, vegetables, fruits, flowers, empty palm fruit bunch, and energy cane.

The term “energy cane” refers to sugar cane that is bred for use in energy production. It is selected for a higher percentage of fiber than sugar. The term “lignocellulosic biomass hydrolysate” refers to the product resulting from saccharification of lignocellulosic biomass. The biomass may also be pretreated or pre-processed prior to saccharification.

The term “lignocellulosic biomass hydrolysate fermentation broth” is broth containing product resulting from biocatalyst growth and production in a medium comprising lignocellulosic biomass hydrolysate. This broth includes components of lignocellulosic biomass hydrolysate that are not consumed by the biocatalyst, as well as the biocatalyst itself and product made by the biocatalyst.

The term “slurry” refers to a mixture of insoluble material and a liquid. A slurry may also contain a high level of dissolved solids. Examples of slurries include a saccharification broth, a fermentation broth, and a stillage.

The term “whole stillage” refers to the bottoms of a distillation. The whole stillage contains the high boilers and any solids of a distillation feed stream. Whole stillage is a type of depleted broth.

The term “thin stillage” refers to a liquid fraction resulting from solid/liquid separation of a whole stillage, fermentation broth, or product depleted fermentation broth.

The term “product depleted broth” or “depleted broth” refers herein to a lignocellulosic biomass hydrolysate fermentation broth after removal of a product stream.

The terms “lignocellulosic syrup” or “syrup” mean a concentrated product produced from the removal of water, generally by evaporation, from thin stillage.

The term “untreated lignocellulosic syrup”, as used herein, refers to syrup that has not been treated either enzymatically or chemically or both, to reduce or eliminate concentration of undesirable components such as acetamide in it.

The term “pretreated lignocellulosic syrup” refers to syrup that has gone through either a chemical or an enzymatic treatment or both to reduce or eliminate its undesirable components.

The term “target product” refers to any product that is produced by a microbial production host cell in a fermentation process. Target products may be the result of genetically engineered enzymatic pathways in host cells or may be produced by endogenous pathways. Typical target products include but are not limited to acids, alcohols, alkanes, alkenes, aromatics, aldehydes, ketones, biopolymers, proteins, peptides, amino acids, vitamins, antibiotics, and pharmaceuticals.

The term “fermentation” refers broadly to the use of a biocatalyst to produce a target product. Typically the biocatalyst grows in a fermentation broth utilizing a carbon source in the broth, and through its metabolism produces a target product.

“Solids” refers to soluble solids and insoluble solids. Solids from a lignocellulosic fermentation process contain residue from the lignocellulosic biomass used to make hydrolysate medium.

“Volatiles” refers herein to components that will largely be vaporized in a process where heat is introduced. Volatile content is measured herein by establishing the loss in weight resulting from heating under rigidly controlled conditions to 950° C. (as in ASTM D-3175). Typical volatiles include, but are not limited to, hydrogen, oxygen, nitrogen, acetic acid, and some carbon and sulfur.

“Fixed carbon” refers herein to a calculated percentage made by summing the percent of moisture, percent of ash, and percent of volatile matter, and then subtracting that percent from 100.

“Ash” is the weight of the residue remaining after burning under controlled conditions according to ASTM D-3174.

“Sugars” as referred to in the lignocellulosic syrup composition means a total of monosaccharide and soluble oligosaccharides.

As defined herein, “macronutrients” are any nitrogen (N), phosphorus (P), or potassium (K) containing substance which can deliver nutrition to the plant.

As defined herein, “micronutrients” are substances that are required in small amounts for plant growth such as boron (B), calcium (Ca) chlorine (Cl), manganese (Mn), iron (Fe), zinc (Zn), copper (Cu), molybdenum (Mo) and selenium (Se). Hereafter, the term “nutrients” is used for both macro- and micro-nutrients.

As defined herein, “plant” or “plant material” is intended to refer to any part of a plant (e.g., roots, foliage, shoot) as well as seeds, trees, shrubbery, flowers, and grasses.

As defined herein, the term “contacting” refers to mixing, blending, pouring, or dumping together filter cake and lignocellulosic syrup.

As defined herein, the term “plant growth”, refers to any increase of plant biomass comprising at least one of: germination of seeds, emerging of leaves on existing stems, increasing the height of the stem, increasing the width of the stem, increasing the root mass, flowering and fruit/seed production.

As used herein, “moldable” refers to capable of being molded or modeled such as being shaped, formed, bent, or drawn out as by hammering, by applying pressure, extruding, and the like.

As used herein, “block copolymers” refers to polymers that include two or more segments of chemically distinct constitutional repeating units, linked covalently.

### Fermentation of Lignocellulosic Biomass

The lignocellulosic filter cake (hereafter “FC”) suitable for application in the instant disclosure is produced as a co-product from a process that uses lignocellulosic biomass as a source of fermentable sugars which are used as a carbon source for a biocatalyst. The biocatalyst uses the sugars in a fermentation process to produce a target product.

To produce fermentable sugars from lignocellulosic biomass, the biomass is treated to release sugars such as glucose, xylose, and arabinose from the polysaccharides of the biomass. Lignocellulosic biomass may be treated by any method known by one skilled in the art to produce fermentable sugars in a hydrolysate. Typically the biomass is pretreated using physical, thermal and/or chemical treatments, and saccharified enzymatically. Thermo-chemical pretreatment methods include steam explosion or methods of swelling the biomass to release sugars (see for example WO2010113129; WO2010113130). Chemical saccharification may also be used. Physical treatments such as these may be used for particle size reduction prior to further chemical treatment. Chemical treatments include base treatment such as with strong base (ammonia or NaOH), or acid treatment (U.S. Pat. No. 8,545,633; WO2012103220). In one embodiment the biomass is treated with ammonia (U.S. Pat. No. 7,932,063; U.S. Pat. No. 7,781,191; U.S. Pat. No. 7,998,713; U.S. Pat. No. 7,915,017). These treatments release polymeric sugars from the biomass. In one embodiment the pretreatment is a low ammonia pretreatment where biomass is contacted with an aqueous solution comprising ammonia to form a biomass-aqueous ammonia mixture where the ammonia concentration is sufficient to maintain alkaline pH of the biomass-aqueous ammonia mixture but is less than about 12 weight percent relative to dry weight of biomass, and where dry weight of biomass is at least about 15 weight percent solids relative to the weight of the biomass-aqueous ammonia mixture, as disclosed in U.S. Pat. No. 7,932,063, which is herein incorporated by reference.

Saccharification, which converts polymeric sugars to monomeric sugars, may be either by enzymatic or chemical treatments. The pretreated biomass is contacted with a saccharification enzyme consortium under suitable conditions to produce fermentable sugars. Prior to saccharification, the pretreated biomass can be brought to the desired moisture content and treated to alter the pH, composition or temperature such that the enzymes of the saccharification enzyme consortium will be active. The pH can be altered through the addition of acids in solid or liquid form. Alternatively, carbon dioxide (CO₂), which can be recovered from fermentation, can be utilized to lower the pH. For example, CO₂ can be collected from a fermenter and fed into the pretreatment product headspace in the flash tank or bubbled through the pretreated biomass if adequate liquid is present while monitoring the pH, until the desired pH is achieved. The temperature is brought to a value that is compatible with saccharification enzyme activity, as noted below. Typically suitable conditions can include temperature from about 40° C. to about 50° C. and pH between from about 4.8 to about 5.8.

Enzymatic saccharification of cellulosic or lignocellulosic biomass typically makes use of an enzyme composition or blend to break down cellulose and/or hemicellulose and to produce a hydrolysate containing sugars such as, for example, glucose, xylose, and arabinose. Saccharification enzymes are reviewed in Lynd, L. R., et al. (Microbiol. Mol. Biol. Rev., 66:506-577, 2002). At least one enzyme is used, and typically a saccharification enzyme blend is used that includes one or more glycosidases. Glycosidases hydrolyze the ether linkages of di-, oligo-, and polysaccharides and are found in the enzyme classification EC 3.2.1.x (Enzyme Nomenclature 1992, Academic Press, San Diego, Calif. with Supplement 1 (1993), Supplement 2 (1994), Supplement 3 (1995, Supplement 4 (1997) and Supplement 5 [in Eur. J. Biochem., 223:1-5, 1994; Eur. J. Biochem., 232:1-6, 1995; Eur. J. Biochem., 237:1-5, 1996; Eur. J. Biochem., 250:1-6, 1997; and Eur. J. Biochem., 264:610-650 1999, respectively]) of the general group “hydrolases” (EC 3.). Glycosidases useful in saccharification can be categorized by the biomass components they hydrolyze. Glycosidases useful in saccharification can include cellulose-hydrolyzing glycosidases (for example, cellulases, endoglucanases, exoglucanases, cellobiohydrolases, β-glucosidases), hemicellulose-hydrolyzing glycosidases (for example, xylanases, endoxylanases, exoxylanases, β-xylosidases, arabino-xylanases, mannases, galactases, pectinases, glucuronidases), and starch-hydrolyzing glycosidases (for example, amylases, α-amylases, β-amylases, glucoamylases, α-glucosidases, isoamylases). In addition, it can be useful to add other activities to the saccharification enzyme consortium such as peptidases (EC 3.4.x.y), lipases (EC 3.1.1.x and 3.1.4.x), ligninases (EC 1.11.1.x), or feruloyl esterases (EC 3.1.1.73) to promote the release of polysaccharides from other components of the biomass. It is known in the art that microorganisms that produce polysaccharide-hydrolyzing enzymes often exhibit an activity, such as a capacity to degrade cellulose, which is catalyzed by several enzymes or a group of enzymes having different substrate specificities. Thus, a “cellulase” from a microorganism can comprise a group of enzymes, one or more or all of which can contribute to the cellulose-degrading activity. Commercial or non-commercial enzyme preparations, such as cellulase, can comprise numerous enzymes depending on the purification scheme utilized to obtain the enzyme. Many glycosyl hydrolase enzymes and compositions thereof that are useful for saccharification are disclosed in WO 2011/038019 or WO 2012/125937, incorporated herein by reference. Additional enzymes for saccharification include, for example, glycosyl hydrolases that hydrolyze the glycosidic bond between two or more carbohydrates, or between a carbohydrate and a noncarbohydrate moiety.

Saccharification enzymes can be obtained commercially. Such enzymes include, for example, Spezyme® CP cellulase, Multifect® xylanase, Accelerase® 1500, Accellerase® DUET, and Accellerase® Trio™ (Dupont™/Genencor®, Wilmington, Del.), and Novozyme-188 (Novozymes, 2880 Bagsvaerd, Denmark). In addition, saccharification enzymes can be provided as crude preparations of a cell extract or a whole cell broth. The enzymes can be produced using recombinant microorganisms that have been engineered to express one or more saccharifying enzymes. For example, an H3A protein preparation that can be used for saccharification of pretreated lignocellulosic biomass is a crude preparation of enzymes produced by a genetically engineered strain of Trichoderma reesei, which includes a combination of cellulases and hemicellulases and is described in WO 2011/038019, which is incorporated herein by reference.

Chemical saccharification treatments can be used and are known to one skilled in the art, such as treatment with mineral acids including HCl and H₂SO₄ (U.S. Pat. No. 5,580,389; WO2011002660).

Sugars such as glucose, xylose and arabinose are released by saccharification of lignocellulosic biomass and these monomeric sugars provide a carbohydrate source for a biocatalyst used in a fermentation process. The sugars are present in a biomass hydrolysate that is used as fermentation medium. The fermentation medium can be composed solely of hydrolysate, or can include components additional to the hydrolysate such as sorbitol or mannitol at a final concentration of about 5 mM as described in U.S. Pat. No. 7,629,156, which is incorporated herein by reference. The biomass hydrolysate typically makes up at least about 50% of the fermentation medium. Typically about 10% of the final volume of fermentation broth is seed inoculum containing the biocatalyst.

The medium comprising hydrolysate is fermented in a fermenter, which is any vessel that holds the hydrolysate fermentation medium and at least one biocatalyst, and has valves, vents, and/or ports used in managing the fermentation process.

Any biocatalyst that produces a target product utilizing glucose and preferably also xylose, either naturally or through genetic engineering, may be used for fermentation of the fermentable sugars in the biomass hydrolysate made from lignocellulosic biomass. Target products that may be produced by fermentation include, for example, acids, alcohols, alkanes, alkenes, aromatics, aldehydes, ketones, biopolymers, proteins, peptides, amino acids, vitamins, antibiotics, and pharmaceuticals. Alcohols include, but are not limited to methanol, ethanol, propanol, isopropanol, butanol, ethylene glycol, propanediol, butanediol, glycerol, erythritol, xylitol, mannitol, and sorbitol. Acids may include acetic acid, formic acid, lactic acid, propionic acid, 3-hydroxypropionic acid, butyric acid, gluconic acid, itaconic acid, citric acid, succinic acid, 3-hydroxyproprionic acid, fumaric acid, maleic acid, and levulinic acid. Amino acids may include glutamic acid, aspartic acid, methionine, lysine, glycine, arginine, threonine, phenylalanine and tyrosine. Additional target products include methane, ethylene, acetone and industrial enzymes.

The fermentation of sugars in biomass hydrolysate to target products can be carried out by one or more appropriate biocatalysts, that are able to grow in medium containing biomass hydrolysate, in single or multistep fermentations. Biocatalysts may be microorganisms selected from bacteria, filamentous fungi and yeast. Biocatalysts can be wild type microorganisms or recombinant microorganisms, and can include, for example, organisms belonging to the genera of Escherichia, Zymomonas, Saccharomyces, Candida, Pichia, Streptomyces, Bacillus, Lactobacillus, and Clostridiuma. Typical examples of biocatalysts include recombinant Escherichia coli, Zymomonas mobilis, Bacillus stearothermophilus, Saccharomyces cerevisiae, Clostridia thermocellum, Thermoanaerobacterium saccharolyticum, and Pichia stipitis. To grow well and have high product production in a lignocellulosic biomass hydrolysate fermentation broth, a biocatalyst can be selected or engineered to have higher tolerance to inhibitors present in biomass hydrolysate such as acetate. For example, the biocatalyst may produce ethanol as a target product, such as production of ethanol by Zymomonas mobilis as described in U.S. Pat. No. 8,247,208, which is incorporated herein by reference.

Fermentation is carried out with conditions appropriate for the particular biocatalyst used. Adjustments can be made for conditions such as pH, temperature, oxygen content, and mixing. Conditions for fermentation of yeast and bacterial biocatalysts are well known in the art.

In addition, saccharification and fermentation may occur at the same time in the same vessel, called simultaneous saccharification and fermentation (SSF). In addition, partial saccharification may occur prior to a period of concurrent saccharification and fermentation in a process called HSF (hybrid saccharification and fermentation).

For large scale fermentations, typically a smaller culture (seed culture) of the biocatalyst is first grown. The seed culture is added to the fermentation medium as an inoculum typically in the range from about 2% to about 20% of the final volume.

Typically fermentation by the biocatalyst produces a fermentation broth containing the target product made by the biocatalyst. For example, in an ethanol process the fermentation broth may be a beer containing from about 6% to about 10% ethanol. In addition to target product, the fermentation broth contains water, solutes, and solids from the hydrolysate medium and from biocatalyst metabolism of sugars in the hydrolysate medium. Typically the target product is isolated from the fermentation broth producing a depleted broth, which can be called whole stillage. For example, when ethanol is the product, the broth is distilled, typically using a beer column, to generate an ethanol product stream and a whole stillage. Distillation can be using any conditions known to one skilled in the art including at atmospheric or reduced pressure. The distilled ethanol is further passed through a rectification column and molecular sieve to recover an ethanol product. The target product may alternatively be removed in a later step such as from a solid or liquid fraction after separation of fermentation broth.

### Filter Cake and Syrup Production

Lignocellulosic filter cake is produced as a co-product from a lignocellulosic biomass fermentation process. Typically the filter cake is made from whole stillage that remains after distillation of a volatile target product that can be separated from fermentation broth by distillation. In one embodiment, filter cake is produced during fermentation of a lignocellulosic biomass hydrolysate to produce an alcohol such as ethanol. During production of ethanol from lignocellulosic biomass, fermentation broth is distilled to recover ethanol. The fermentation broth is processed in a distillation column to separate the ethanol and some water from the solids and the bulk of the water. Ethanol goes overhead and the solids and water exit the bottom of the column and are called “whole stillage”. The high lignin-content solids in the whole stillage are separated from the liquid typically using a filter press. These solids are called filter cake (hereafter FC) and are then removed from the system. The liquid fraction is further processed by evaporation using a multi-effect, falling film evaporator system and the evaporated water is condensed and treated by anaerobic digestion. Removing the water from the liquid fraction produces high-solids, lignocellulosic syrup.

### Filter Cake Composition

The filter cake can be used wet, or it can be dried which is typically by air drying. The wet lignocellulosic filter cake composition contains from about 35% to 65% moisture (can have about 35%, 40%, 45%, 50%, 55%, 60%, or 65% moisture), from about 20% to about 75% volatiles (can have about 20%, 25%, 30%, 35%, 40%, 45%, 50%, 55%, 60%, 65%, or 75% volatiles), from about 35% to 65% solids (can have about 35%, 40%, 45%, 50%, 55%, 60%, or 65% solids), from about 1% to about 30% ash (can have about 1%, 3%, 5%, 10%, 15%, 20%, 25%, or 30% ash), from about 5% to about 20% fixed carbon, and it has an energy value of about 2,000 to about 9,000 BTU/lb (can have about 2,000, 2,500, 3,000, 3,500, 4,000, 4,500, 5,000, 5,500, 6,000, 6,500, 7,000, 7,500, 8,000, 8,500, or 9,000 BTU/lb). The volatile content is measured by establishing the loss in weight resulting from heating under rigidly controlled conditions to 950° C. (as in ASTM D-3175). Typical volatiles include hydrogen, oxygen, nitrogen, acetic acid, and some carbon and sulfur. Ash is determined by weighing the residue remaining after burning under controlled conditions according to ASTM D-3174. The amount of fixed carbon is calculated by adding the percentages of moisture, ash, and volatiles, and then subtracting from 100. The full upper range of BTU/lb is typically achieved with drying. FC can be dried and/or processed, such as using a hammermill, into particles prior to application.

For the practice of the instant disclosure, the FC obtained from fermentation of lignocellulosic biomass can be used as is or it can be dried to reduce its moisture content from between about 40 wt % and about 60 wt %, to between about 0 and about 50 wt % based on the total weight of the filter cake. Alternatively, the moisture content of the FC can be from about 0 to about 40 wt % based on the total weight of the filter cake.

Further, the moisture content of the FC can be from about 0 to about 20 wt % based on the total weight of the filter cake. In an embodiment of the instant disclosure the moisture content of the FC is about 5%.

Reducing the amount of moisture in the FC can be achieved using methods well known to those experienced in the relevant art such as conventional ovens, microwave ovens, air dryers, etc. Alternatively, the FC can be left at ambient temperature (from about 15 to about 30 ° C.) to air dry.

### The Syrup Composition

The syrup composition contains from about 40% to about 52% solids, from about 10 g/l to 30 g/l of acetamide, at least about 40 g/l of sugars, a density of about 1 to about 2 g/cm³, and viscosity less than 500 SSU at 100 ° F. (38° C.). “SSU” is Saybolt Universal Viscosity in Seconds. The extent of evaporation may be modulated to achieve the desired solids content. When the pretreatment process used to prepare the biomass for saccharification is a process that uses ammonia, the syrup contains at least about 5 g/l of ammonia. Syrup can be further evaporated or partially dried to facilitate further manipulations. In one embodiment syrup is evaporated such that it contains from about 55% to about 60% solids.

### Composite Composition

The present composition is a composite of the lignocellulosic biomass fermentation process co-product lignocellulosic filter cake and at least one polymer, which is a moldable composite composition. In various embodiments the composite composition optionally contains lignocellulosic syrup. In various embodiments the composite composition contains about 1, 5, 10, 15, 20, 25, 30, 35, 40, 45, 50, 55, or 60 wt % of lignocellulosic filter cake. In various embodiments the composite composition contains about 30, 35, 40, 45, 50, 55, 60, 65, 70, 75, 80, 85, 90, 95, or 99 wt % of polymer. In various embodiments when lignocellulosic syrup is included, the syrup is about 1, 5, 10, 15, or 20 wt % of the total composite composition weight.

In various embodiments, the polymer of the composite composition is at least one of an organic polymer, a polymer derived from petrochemicals, a copolymer, a block copolymer, a natural polymer, and a partially natural polymer.

In various embodiments, the polymer of the composite composition is a thermoplastic polymer or a crosslinkable polymer. These types of polymers provide the composite with moldability using heat treatments or crosslinking treatments, as are known to one of skill in the art. The composite composition may be molded into a form such as a film, an object, a pellet and the like. An object may be, for example, a container such as a pot, jar, bucket, bag, box, tray, multi-well planting tray, and the like. The form may be smooth, textured, or have a combination of smooth and textured portions.

Examples of polymers that may be present in the composite composition are poly(lactic acid), poly(L-lactic acid), poly(D-lactic acid), poly(D,L-lactic acid), poly(meso-lactic acid), poly(rac-lactic acid), or poly(D, L-lactic acid), poly(hydroxyalkanoate), poly(styrene), poly(hydroxybutyrate), poly(hydroxybutyrate-co-valerate), poly(1,3-propanediol succinate), poly(propylene succinate), polyglycolide, poly(caprolactone), poly(butylene succinate), poly(butylene succinate-co-adipate), polyethylene, poly(ethylene succinate), polycarbonate, poly(ethylene carbonate), poly(ethylene glycol), poly(propylene carbonate), poly(alkyl acrylate), poly(alkyl methacrylate), poly(vinyl acetate), poly(vinyl pyridine), poly(acrylic acid), poly(meth)acrylic acid, polyphosphazene, polyimide, polyanhydride, polyamine, polydiene, polyacrylamide, poly(siloxane), poly(butylene terephthalate adipate), poly(propylene terephthalate succinate), poly(propylene terephthalate adipate), poly(vinyl alcohol), poly(vinyl ester), poly(vinyl ether), polyolefin, polyurethane, polysulfone, polysulfide, cellulose acetate, cellulose butyrate acetate, epoxy resins, alkyd resins, polyolefins, photodegradable polymers, polyesters, polyamides, natural rubber, and crosslinked versions thereof, copolymers thereof, co block polymers thereof, and combinations thereof.

In various embodiments, the polymer of the composite composition is a non-biodegradable polymer or a biodegradable polymer. When using a biodegradable polymer the composite composition may have enhanced degradation due to the presence of the filter cake and syrup which contain sugars that can aid microbial growth for the degradation process. In addition, degradation of these co-products by microbial action releases humic and fulvic acids which enhance the quality of soil. Examples of biodegradable polymers include, but are not limited to, polyesters, poly(lactic acid), poly(L-lactic acid), poly(D-lactic acid), poly(D,L-lactic acid), stereocomplexes of poly(L-lactic acid) with poly(D-lactic acid) and poly(hydroxyl alkanoate)s, polybutylene succinate, and polybutylene succinate adipate, crosslinked versions thereof, plasticized versions thereof, copolymers thereof and combinations thereof.

In various embodiments the present composite composition includes at least one additional component such as a plasticizer, toughener, crosslinkiing agent, compatibilizer, impact modifier, nucleating agent, degradation additive, and the like.

In one embodiment the present composite composition lacks plant nutrients, such as macronutrients and micronutrients. In one embodiment the present composite composition lacks additives.

### Composite Material

A composite material is made by contacting lignocellulosic filter cake, at least one polymer (described above), and optionally lignocellulosic syrup to form a composite mixture, then molding the mixture into a form that is useful in a landscape or agricultural application. In some embodiments of the form, the filter cake and polymer are intermixed in one layer rather than forming separate layers. The mixture is molded using any method known to one skilled in the art for molding a polymer. Molding methods include, but are not limited to, applying pressure, extruding, pelleting, forming in a mold, and the like. The particular molding conditions used will depend on the type of polymer included in the mixture. For example, a thermoplastic polymer is molded using heat and a crosslinkable polymer is molded using crosslinking conditions. In various embodiments the composite material is in the form of a film, an object, and a pellet which can be smooth, textured, or have portions that are smooth and portions that are textured. Composite material objects may be any that are useful for landscape or agricultural applications such as pots, jars, buckets, bags and the like.

### Landscape and Agricultural Applications

In various embodiments the present composite composition is applied to a landscape or agricultural site. In various embodiments the composite composition is in a form such as a film, an object, a pellet, and the like. A film or pellets of the present composite composition, which are types of the present composite material, may be applied to the ground surface for landscape or agricultural uses such as preventing erosion, blocking weeds, retaining moisture, mulching, and the like. Containers of the present composite composition, which are types of the present composite material, may be used to hold soil, fertilizer, or other landscape or agricultural materials, may be pots for plants, and the like. These composite materials may be biodegradable or not biodegradable depending on the type of polymer in the composite. Biodegradable composite materials may decompose during a growing season or may be plowed into the soil eliminating the need to recover the material.

### EXAMPLES

This disclosure is further described and illustrated in, but not limited to, the following specific embodiments.

### Abbreviations

The meaning of abbreviations used is as follows: “s” is second, “min” means minute(s), “h” or “hr” means hour(s), “μL” or “μl” means microliter(s), “mL” or “ml” means milliliter(s), “L” or “l” means liter(s), “m” is meter, “nm” means nanometer(s), “mm” means millimeter(s), “cm” means centimeter(s), “μm” means micrometer(s), “mM” means millimolar, “M” means molar, “mmol” means millimole(s), “μmole” means micromole(s), “g” means gram(s), “μg” means microgram(s), “mg” means milligram(s), “kg” is kilogram, “rpm” means revolutions per minute, “C” is Centigrade, “ppm” means parts per million, “cP” is centipoise, “g/l” means grams per liter, “SSU” is Saybolt Universal Viscosity in Seconds, “μE/m²” is microeinsteins per square meter.

### Example 1

### Preparation of a Filter Cake and Polymer COmposite Composition Material

Lignocellulosic filter cake was partially dried to 14 wt % water content and ground using a coffee grinder. A carver press was heated to 150° C. and 5.0 g of poly(butylene succinate-co-adipate) pellets (Bionolle® 3020; obtained from Showa Denko K. K.) were placed on a Teflon® sheet onto a metal platen. After 5 min, the pellets melted. Then, 3.15 g of the dried lignocellulosic filter cake was added in four portions to the melted pellets, with manual mixing using a metal spatula. The mixture was then pressed into an approximately 30 mil thick sheet, by placing a second Telfon® sheet on top of the mixture and lowering the top platen and applying pressure. The resultant opaque brown sheet retained the flexibility of the base polymer and did not exhibit foaming or major defects.

1. A composite composition comprising:
a) lignocellulosic filter cake;
b) at least one polymer; and
c) optionally lignocellulosic syrup;
wherein the composition is moldable.

2. The composition of claim 1 wherein the lignocellulosic filter cake and the lignocellulosic syrup are co-products of a lignocellulosic biomass fermentation process.

3. The composition of claim 1 wherein the polymer is a thermoplastic polymer or a crosslinkable polymer.

4. The composition of claim 1 wherein the polymer is a non-biodegradable polymer or a biodegradable polymer.

5. The composition of claim 1 wherein the polymer is at least one of an organic polymer, a polymer derived from petrochemicals, a copolymer, a block copolymer, a natural polymer, and a partially natural polymer.

6. The composition of claim 1 wherein the polymer is selected from the group consisting of poly(lactic acid), poly(L-lactic acid), poly(D-lactic acid), poly(D,L-lactic acid), poly(meso-lactic acid), poly(rac-lactic acid), or poly(D,L-lactic acid), poly(hydroxyalkanoate), poly(styrene), poly(hydroxybutyrate), poly(hydroxybutyrate-co-valerate), poly(1,3-propanediol succinate), poly(propylene succinate), polyglycolide, poly(caprolactone), poly(butylene succinate), poly(butylene succinate-co-adipate), polyethylene, poly(ethylene succinate), polycarbonate, poly(ethylene carbonate), poly(ethylene glycol), poly(propylene carbonate), poly(alkyl acrylate), poly(alkyl methacrylate), poly(vinyl acetate), poly(vinyl pyridine), poly(acrylic acid), poly(meth)acrylic acid, polyphosphazene, polyimide, polyanhydride, polyamine, polydiene, polyacrylamide, poly(siloxane), poly(butylene terephthalate adipate), poly(propylene terephthalate succinate), poly(propylene terephthalate adipate), poly(vinyl alcohol), poly(vinyl ester), poly(vinyl ether), polyolefin, polyurethane, polysulfone, polysulfide, cellulose acetate, cellulose butyrate acetate, epoxy resins, alkyd resins, polyolefins, photodegradable polymers, polyesters, polyamides, natural rubber, and crosslinked versions thereof, copolymers thereof, co block polymers thereof, and combinations thereof.

7. The composition of claim 1 wherein the composition is in a form selected from the group consisting of a film, an object, and a pellet; wherein the form is smooth, textured, or a combination thereof.

8. A method for preparing a landscape or agricultural composite material comprising:
a) providing lignocellulosic filter cake;
b) providing at least one polymer;
c) optionally providing lignocellulosic syrup;
d) contacting the lignocellulosic filter cake of (a), the polymer of (b); and optionally the lignocellulosic syrup of (c) forming a composite mixture;
e) molding the composite mixture of (d) into a form;
wherein the form is a composite material that is applicable to landscape or agricultural uses.

9. The method of claim 8 wherein the lignocellulosic filter cake and the lignocellulosic syrup are co-products of a lignocellulosic biomass fermentation process.

10. The method of claim 8 wherein the polymer is a non-biodegradable polymer or a biodegradable polymer.

11. The method of claim 8 wherein the polymer is at least one of an organic polymer, a polymer derived from petrochemicals, a copolymer, a block copolymer, a natural polymer, and a partially natural polymer.

12. The method of claim 8 wherein the polymer is selected from the group consisting of poly(lactic acid), poly(L-lactic acid), poly(D-lactic acid), poly(D,L-lactic acid), poly(meso-lactic acid), poly(rac-lactic acid), or poly(D,L-lactic acid), poly(hydroxyalkanoate), poly(styrene), poly(hydroxybutyrate), poly(hydroxybutyrate-co-valerate), poly(1,3-propanediol succinate), poly(propylene succinate), polyglycolide, poly(caprolactone), poly(butylene succinate), poly(butylene succinate-co-adipate), polyethylene, poly(ethylene succinate), polycarbonate, poly(ethylene carbonate), poly(ethylene glycol), poly(propylene carbonate), poly(alkyl acrylate), poly(alkyl methacrylate), poly(vinyl acetate), poly(vinyl pyridine), poly(acrylic acid), poly(meth)acrylic acid, polyphosphazene, polyimide, polyanhydride, polyamine, polydiene, polyacrylamide, poly(siloxane), poly(butylene terephthalate adipate), poly(propylene terephthalate succinate), poly(propylene terephthalate adipate), poly(vinyl alcohol), poly(vinyl ester), poly(vinyl ether), polyolefin, polyurethane, polysulfone, polysulfide, cellulose acetate, cellulose butyrate acetate, epoxy resins, alkyd resins, polyolefins, photodegradable polymers, polyesters, polyamides, natural rubber, and crosslinked versions thereof, copolymers thereof, co block polymers thereof, and combinations thereof.

13. The method of claim 8 wherein molding of (e) is by a method selected from the group consisting of extruding, applying pressure, pelleting, forming in a mold, and combinations thereof.

14. The method of claim 8 wherein the form is selected from the group consisting of a film, an object, and a pellet; wherein the form is smooth, textured, or a combination thereof.

15. A method of treating a landscape or agricultural site comprising;
a) providing a composite composition of claim 1; and
b) applying the composite composition of (a) to a landscape or agricultural site.
